(19) United States
(12) Patent Application Publication
(10) Pub. No.: US 2008/0108249 A1
(43) Pub. Date: May 8, 2008

(54) METHODS AND IMPROVED APPARATUS FOR WALL MOUNTED CABLE PORTS

(76) Inventor: David Carman, Exeter, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/927,293

(22) Filed: Oct. 29, 2007

Related U.S. Application Data
(60) Provisional application No. 60/864,669, filed on Nov. 7, 2006.

(51) Int. Cl. H01R 13/60; H01R 13/73

(52) U.S. Cl. 439/535

(57) ABSTRACT

A novel enhanced system for connecting to preexisting wiring in buildings allows users with little experience wiring walls to safely change wiring receptacles and change the wiring at outlets throughout the building. Use of such a system improves safety by preventing contact with exposed wires. Moreover, users may exchange or replace wire behind wall using a novel replacement system.

### RELATED APPLICATIONS

This application claims the Paris Convention priority and incorporates by reference U.S. Provisional Patent Application Ser. No. 60/864,669 filed on 11 Nov. 2006 entitled “Methods and Improved Apparatus for Wall Mounted Cable Ports.”

### BACKGROUND

Average people who attempt to replace or, upgrade electrical and utility wire connections installed in the walls of buildings are exposed to electrocution, fire, and other safety hazards. The present disclosure provides a novel enhanced system and methods for safely optimizing, replacing, and choosing wire connections in buildings.

### SUMMARY

A novel enhanced system for connecting to preexisting wiring in buildings allows users with little experience wiring walls to safely change wiring receptacles and change the wiring at outlets throughout the building. Use of such a system improves safety by preventing contact with exposed wires. Moreover, users may exchange or replace wire behind wall using a novel replacement system.

According to a feature of the present disclosure, a device is disclosed comprising a removable wiring port having at least one internal wiring connector and a wiring port housing having at least one internal receptacle connected to the wiring of a building. The removable wiring port further optionally comprises at least an external wiring connector connected to at least one internal wiring connector.

According to a feature of the present disclosure, a device is disclosed comprising a removable wiring port having at least one internal wiring connector and a wiring port housing having at least one internal receptacle connected to the wiring of a building. The removable wiring port is optionally integrated into a second device, where the internal wiring connector connects directly to the second device.

According to a feature of the present disclosure, a device is disclosed comprising a removable wiring port having at least one internal wiring connector and a wiring port housing having at least one internal receptacle connected to the wiring of a building, where the removable wiring port is a safety port that is disconnected from the at least one internal wiring connector.

According to a feature of the present disclosure, a modular wiring unit is disclosed comprising at least one wire grouped as a set of replaced wires having a replaced wire end unit, a coupler, and at least one wire group as a set of replacement wires having a replacement wire end unit. The coupler reversibly connects the replaced wire end unit and the replacement wire end unit whereby the replace wire may be pulled from another end to replace the replaced wire with the replacement wire.

According to a feature of the present disclosure, a method is disclosed comprising providing a removable wiring port to be installed into a housing for the removable wiring port with connectors for engaging the removable wiring port to live wiring, the removable wiring port having an engagement member to releasably engage the removable wiring port with live wiring.

According to a feature of the present disclosure, a method using a removable wiring port is disclosed comprising inserting a removable wiring port into a wiring port housing, wherein the removable wiring port comprises at least an external wiring connector and an internal wiring connector connected to each external wiring connector and the removable port housing comprises at least one internal receptacle connected to the wiring of a building.

According to a feature of the present disclosure, a method is disclosed comprising providing a building wire connector replacement to provide a safe system for replacing building wire connectors, the wire connector replacement system further comprising: a removable wiring port having at least one external wire connector to connect to apparatuses in the building requiring a wire connection, the removable wiring port having internal wiring connectors that are in a retracted position until an engagement member is actuated; a wiring port housing connected to preexisting wiring of the building having internal wiring receptacles for receiving the internal wiring connectors after the engagement member is actuated. A user inserts the removable wiring port into the wiring port housing and actuates an engagement member and the user is never exposed to live wires.

### DRAWINGS

The above-mentioned features and objects of the present disclosure will become more apparent with reference to the following description taken in conjunction with the accompanying drawings wherein like reference numerals denote like elements and in which:

FIG. 1 is a three-dimensional perspective of an embodiment of a removable wiring port;

FIG. 2 is a three-dimensional perspective of an embodiment of a wiring port housing;

FIG. 3 is a three-dimensional perspective of an embodiment of a removable wiring port;

FIGS. 4 and 5 are three-dimensional perspectives of an embodiment of the mounting brackets with stress bars;

FIG. 6 is a three-dimensional perspective of an embodiment of the coupler and modular wire replacement unit;

FIG. 7 is a three-dimensional perspective of an embodiment of a replace wire and a replaced wire end unit; and

FIGS. 8 and 9 are three dimensional perspectives of an embodiment of wall-mounted stress bars designed to integrate with removable wiring ports.

### DETAILED DESCRIPTION

Nearly every building today in the United States is equipped with some combination of electrical sockets, telephone jacks, cable jacks, and so forth. Generally, however, unless the person using the building is involved in the design process of the building, the placement of each individual type of socket, jack, or port is limited. This affects placement of furniture and often results in unsightly wiring solutions that may include exposed wire or jury-rigging wires through walls, under carpet, etc. to bring the socket to the device.

Perhaps more importantly, average home users often lack the experience to install the sockets they desire at a particular socket, jack, or port (collectively ports) location. Thus, the port locations in the building are typically static to the average user. Many users, however, desire to choose where various ports are located, such as cable jacks or telephone jacks, or wish to install jacks that are not available. Often, installation of a desired port requires rewiring behind walls and expertise to install the correct hardware.

Importantly, where electrical ports are involved, inexperienced users must take measures to avoid electrocution. The user must shut off the building power or know how to disable the power for a specific port to avoid electrocution. Most people using buildings, however, are electrically inexperienced, which requires them to either expose themselves to live electrical wiring or hire an electrician to install the wiring.

The present inventor discovered a novel way to provide a modular port system that average home users may use for increased safety, ease of use, and for selection of ports according to the user's individual taste. Using the systems and methods of the present disclosure, persons using a building may safely add and remove ports as desired. For example, unneeded electrical sockets may be removed where young children play, without risking electrocution and without needing specialized expertise. Additionally, users can arrange the furniture in rooms without the need to consider where the ports, such as cable jack, networking, and so forth are located. Moreover, inexperienced users may incorrectly wire outlets, which potentially causes fires. Thus, inexperienced users need not have any specific know-how relating to a wiring system to correctly wire the receptacle.

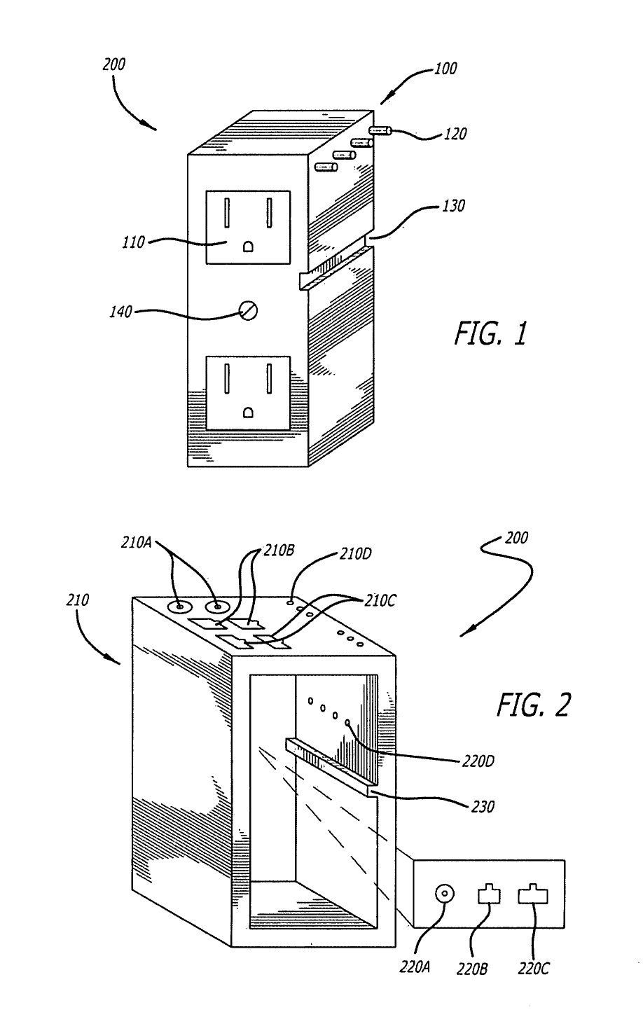

According to an embodiment shown in FIG. 1, there is shown removable wiring port 100. Removable wiring port 100 comprises external wiring connectors 110, internal wiring connectors 120, alignment guide 130, and engagement member 140. Depending on the ports configured for each removable wiring port 100, the internal wiring will be known and understood by artisans. Indeed, traditional wiring methods inside removable wiring port 100 are appropriate for electrical, telephone, video, audio, and other applications.

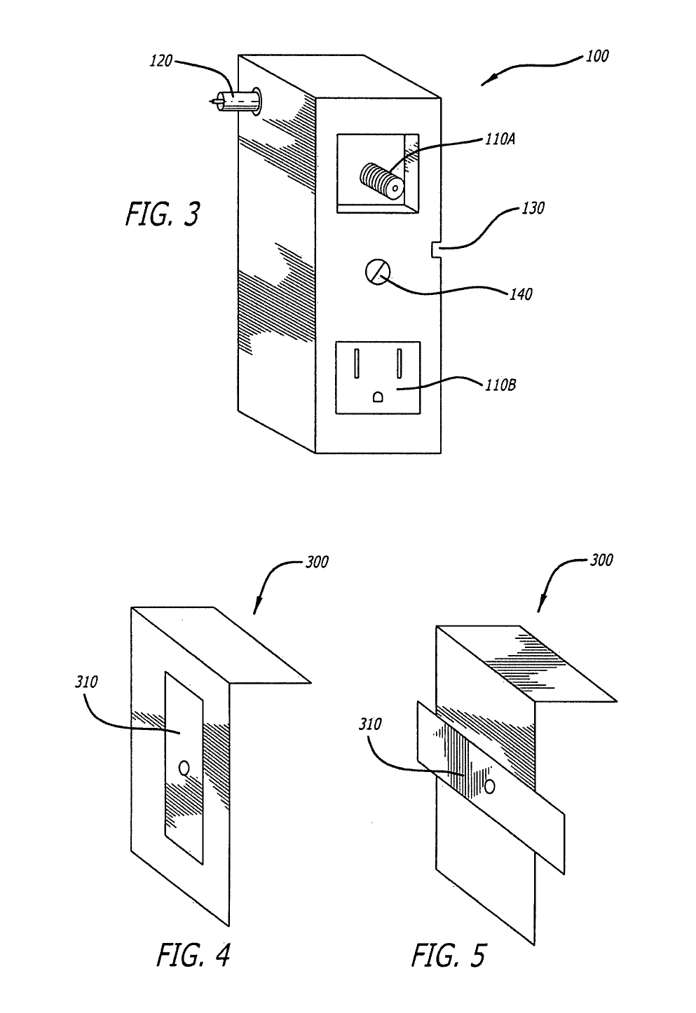

External wiring connectors 110 provide specific ports to connect to implements requiring electricity such as lamps, computers, appliances, and so forth. These ports are well known in the art. For example, electrical ports are shown in FIG. 1, according to an embodiment FIG. 3 demonstrates an alternate embodiment exemplifying the flexibility of the type of ports that may be installed. Any number of ports may be combined on each removable wiring port. For example, external wiring connectors 110 used near a television may be installed with an electrical port, a coaxial cable port, and ethernet port to connect a DVR to other computer systems in a building, and audio connectors for a surround sound system. Similarly, external wiring connections 110 in an area that houses a phone may comprise simple of an electrical port and a telephone jack port. According to embodiments, portless removable wiring port 100 may be provided and installed for child safety (where the ports will not be used) or for the possibility of future port needs.

According to embodiments, internal wiring connectors 120 interconnect with internal wiring receptacles 220 (see, e.g., FIG. 2) of removable wiring port housing 200, which connects external wiring connector 110 to live wiring throughout a building, as would be known and understood by artisans. According to embodiments, internal wiring connectors 120 are designed for precise alignment with internal wiring receptacles 220 of wiring port housing 200.

Alignment guide system comprising of female alignment guide 130 (FIG. 1) and male alignment guide 230 (FIG. 2) are provided to ensure internal wiring connectors 120 and internal wiring receptacles 220 are precisely aligned for successful interconnection during the installations process, according to embodiments. Artisans will understand that alignment guide system is an optional component. According to embodiments, removable wiring port 100 and wiring port housing 200 may be designed sans alignment guide system to fit together with relative precision great enough to ensure successful interconnection of internal wiring connectors 120 and internal wiring receptacles 220.

Prior to installation of removable wiring port 100 into wiring port housing 200, internal wiring connectors 120 may be retracted into removable wiring port 100, according to embodiments. Thus, as a person installs removable wiring port 100 into wiring port housing 200, internal wiring connectors 120 will never engage with internal wiring receptacles 220, which will prevent wiring in removable wiring port 100 from becoming live until engagement member 140 is activated. Consequently, the person installing removable wiring port 100 will never contact exposed wiring and risk electrocution or damage to sensitive components.

Engagement member 140 is used to lock removable wiring port 100 into wiring port housing 200. According to embodiments, engagement member 140 causes retracted internal wiring connectors 120 to de-retract into the position shown in FIG. 1, thereby interconnecting with internal wiring receptacles 220. According to embodiments, interconnection by internal wiring connectors 120 into internal wiring receptacles 220 will lock removable wiring port 100 into wiring port housing 200 via internal wiring connectors 120 or via dedicated locking members, which would be understood by artisans.

According to an embodiment shown in FIG. 2, wiring port house 200 is designed to receive removable wiring port 100. Wiring port house 200 comprises external wiring receptacles 210, internal wiring receptacles 220, and optional alignment guide 230. Artisans will understand that the terms “receptacle” and “connector” are freely interchangeable, as it will be generally understood that male and female wiring components are freely exchangeable depending on the specific wiring installation in a building and the types of ports installed. Indeed, artisans will appreciate that male and female wiring components may be substituted with contact members or equivalents, as known in the art.

External wiring receptacles 210 provide a point of connection between wiring port housing 200 and the wiring within the walls, floors, ceilings, or other concealed areas of a building, which then connect installed removable wiring port 100 to the building wiring. According to embodiments, external wiring receptacles 210 may comprise one or more ports for traditional connection of various types of wires—for example RJ-11, RJ-14, RJ-25, RJ-61, RJ-45, or coaxial cable ports. Similarly, and not mutually exclusive, external wiring receptacles 210 may simply comprise contact points for exposed wires to interconnect with wiring port housing 200. A person of ordinary skill in the art will know and understand how to implement external wiring receptacles in a desired manner according to installations.

For example, according to the embodiment shown in FIG. 2, there is shown external wiring receptacles 210A, 210B, 210C, and 210D. External wiring receptacles 210A, 210B, and 210C are modular coaxial cable receptacle 210A, telephone receptacle 210B (RJ-11, RJ-14, RJ-25, or RJ-61 depending on the wiring in the house), and ethernet receptacle 210C (RJ-45). Electrical external wiring receptacles 210D are not modular and will be connected as would be known to artisans, by soldering or simple male-female connectors for example.

External wiring receptacles 210 connect to internal wiring receptacles 200. As shown by the perspective in FIG. 2, electrical internal wiring receptacles 220D are shown in profile and, as described previously, connect to internal wiring connectors 120. Also shown in explosion are coaxial internal wiring receptacle 220A, telephone internal wiring receptacle 220B, and ethernet internal wiring receptacle 220C. According to embodiments, these last three receptacles are positioned opposite of electrical internal wiring receptacle. Nevertheless, according to embodiments, the placement of all internal wiring receptacles 220 may be a matter of preference.

Configuration wherein external wiring receptacles 210 are modular is desired in circumstances where wiring port housing 200 is designed to be removable. In these instances, the ability to rapidly and safely remove wall wiring from wiring port housing 200 will be desired. Modular connections, naturally, provide a system from easy removal of wires without the attendant safety hazard accompanying use of live wires that are merely stripped and mechanically connected to external wiring receptacles 210, as would be known to artisans.

An embodiment shown in FIG. 3 demonstrates the flexibility of the present disclosure in allowing a person living or working in a building to select ports on removable wiring port 100 for a particular purpose. The embodiment shown in FIG. 3 is identical to the embodiment shown in FIG. 1, except for the ports selected by the user. In this case, external wiring connectors 110 comprise coaxial cable port 110A and electrical port 110B. Internal wiring connectors 120 for electrical port are not shown, but the same as in FIG. 1 on the opposite side of internal wiring connector 120 for the coaxial cable jack. Thus, this particular embodiment of removable wiring port 100 may be used in close proximity to a desired placement of a television to dispense with the need to string or jury rig wire from the original location of the coaxial cable port to the television, cable box, or DVR, for example. Artisans will recognize that wiring port housing 200 may receive any number of embodiments of removable wiring port 100 with many combinations of external wiring connectors 110 without the need to make any modifications to the wiring of the building to provide the safety and functionality of simply removing one removable wiring port 100 and replacing it with another with more desirable external wiring connectors 100. According to embodiments, each wiring port housing 200 will be configured for nearly any type of jack, including but not limited to electrical; analog and digital video and audio, networking, and so forth.

As previously described, internal wiring within the system will not be exposed to users of the system according to embodiments, reducing the risk of electrocution and allowing consumers to freely upgrade the port system in their homes. Consumers will not need to hire electricians, but will need only disengage removable wiring port 100 from wiring port housing 200, remove removable wiring port 100 and replace it with another. The present disclosure expressly contemplates according to embodiments, that the replacement may be accomplished via a portless faceplate. Artisans will known and understand how to implement such a faceplate.

According to embodiments, other, non-port features may be installed into removable wiring port 100 such as surge protectors, fuses, light emitting diodes to show network activity, switches, etc. Generally, artisans will appreciate the non-port features and advantages that may be desirable depending on external wiring connectors 110 installed in each embodiment of removable wiring port 100.

According, to embodiments, removable wiring port 100 comprises a base for the recharging of consumer electronics including cellular phones, pagers, and other portable electronics. Removable wiring port 100 comprises the circuitry to charge the device. The outward appearance of the device comprises a cradle in which the consumer electronic product is placed to charge. LED's may be installed in removable wiring port 100 as status indicators, according to embodiments.

According to embodiments, the devices of the present disclosure are ideal for computer equipment connections, as previously disclosed. According to further embodiments, removable wiring port 100 may have “built-in” surge protected power cables compatible with a computer's power supply and display, together with an outlet for a surge protector used to power the other peripheral devices and a telephone jack, cable jack, or ethernet port to connect to the internet via a modem, cable modem, DSL, line, or ethernet cable.

According to embodiments, removable wiring port 100 may be configured to connect 220V devices (in the United States), giving flexibility for appliance positioning, especially for power tools, washing machines and dryings, refrigerators, and oven/ranges.

According to embodiments, removable wiring port 100 may comprise motion sensors. Recently, for example, motion sensors are being placed in the homes of the elderly to monitor the elderly person's movement throughout the home. Lack of movement detected by the motion sensors may indicate a potential problem.

According to embodiments, removable wiring port too are used as an end of extension cords, to ensure the extension cord cannot be disconnected from its source. The extension cord may have a built-in ground fault interrupter. According to other embodiments, microelectronics may be installed to monitor electrical consumption, network activity, etc. and provide a log to interested parties.

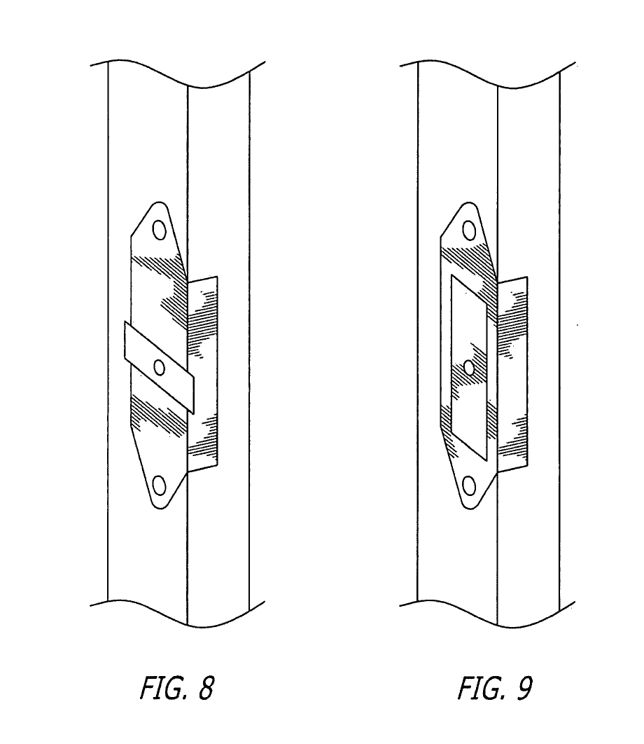

FIGS. 4 and 5 demonstrate and embodiment of strain bar 310 mounted to mounting bracket 300. Strain bar 310 articulates with wiring port housing 200. When connections are made or removed with external wiring connections such as external cables, the brunt of the strain from insertion and removal of cable ends in external wiring connectors 110 will be born by strain bar 310, preventing damage to removable wiring port 100 or wiring port housing 200. Strain bar 310 is especially useful in ceiling mounted units such as lighting fixtures and fans that may hang from the system of the present disclosure. In these cases, strain bar 310 will bear the weight of the hanging implements, not removable wiring port 100 or wiring port housing 200. Mounting bracket 300 may be attached to the frame of the building, according to embodiments (shown in FIGS. 8 and 9). Artisans will appreciate how strain bar 310 and mounting bracket 300 may be designed and installed.

According to embodiments, ceiling units are designed to have built in removable wiring port 100. Thus, an lay person can install the ceiling unit simply by removing the removable wiring port 100 present prior to installation of the ceiling unit, and insert the removable wiring port portion of the ceiling unit into wiring port housing 200 and engaging removable wiring port, which powers the ceiling unit and engages the strain bar.

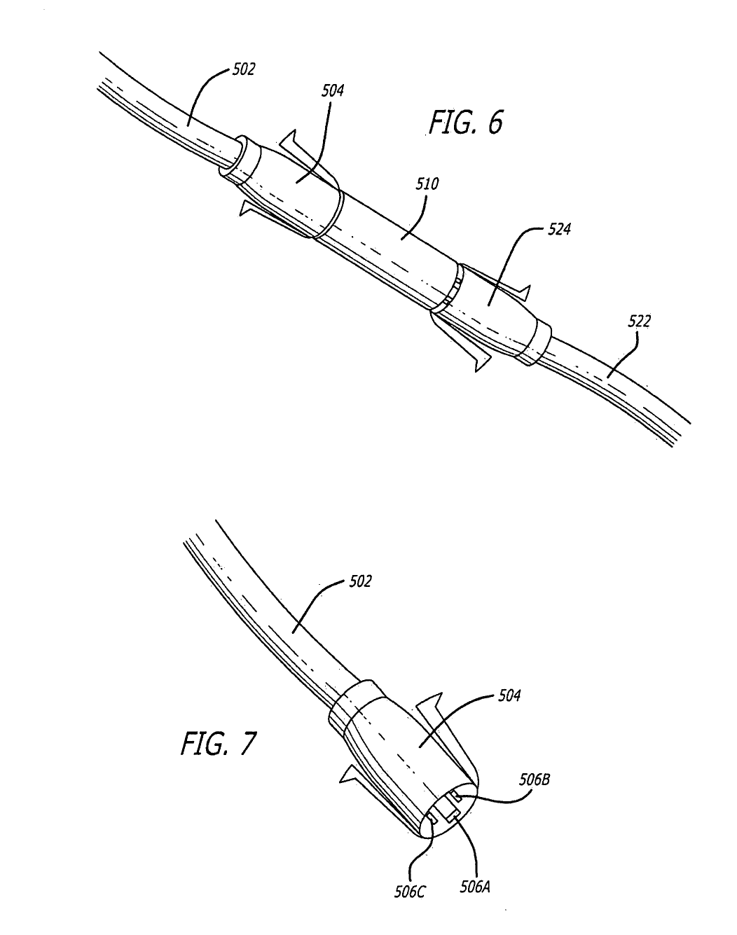

A modular wiring unit may be used according to the embodiment shown in FIGS. 6 and 7. Buildings are typically wired during construction. After construction is completed, replacement or addition of wiring is more difficult. According to embodiments shown in FIGS. 6 and 7, modular wiring replacement unit 500 may be installed in buildings to facilitate ease of replacement and addition.

According to embodiments, modular wire replacement unit 500 comprises replaced wire 502, replaced wire end unit 504, coupler 510, replacement wire 522, and replacement wire end unit 524. According to embodiments, a puller may be included that couples to the distal end of replaced wire 502 and comprises a handle for pulling replaced wire 502 and installation of replacement wire 524.

Replaced wire 502 and replacement wire 522 may be the same type of wire or a different type of wire. According to embodiments, dummy wires may be placed into walls during building for the express purpose of being replaced by replacement wire 522 as technology changes. Replaced wire 502 and replacement wire 522 may, according to embodiments, be “complete” wires, that is wires that are dedicated to a single application. For example, replaced wire 502 may be an RJ-25 phone wire that can support up to three phone lines. Alternatively, according to embodiments, replaced wire 502 and replacement wire 522 may comprise single wires, for example the “red channel” of component video cables. Artisans will understand and appreciate the considerations to decide the exact composition of both replaced wire 502 and replacement wire 522. According to embodiments, replacement wire 522 may comprise a plurality of independent wires.

Replaced wire end unit 504 and replacement wire end unit 524 are installed on both ends of each of replaced wire 502 and replacement wire 502. Coupler 510 may be securely attached to replaced wire end unit 502 and replacement wire end unit 524 such that, during the wire replacement process, coupler 510 will not disengage from replaced wire 502 and replacement wire 522.

End units 504, 524 may be universal modular units according to embodiments. Naturally, external wiring receptacles 210 of wiring port housing 200 and coupler 510 will be configured to accept the universal design. Use of a universal design allows for a different type of wire to comprise replacement wire 524 than replaced wire 502. Moreover, only one coupler 510 design must be produced to effect all wire replacement in a building regardless of the type or function of the wires being replaced and installed.

According to other embodiments, end units 504, 524 may comprise standard modular wire end units depending on the wire type, as known to artisans. In order for wires intended for different functions to be replaced, various couplers 510 must be produced to correspond to replaced wire end unit 504 and replacement wire end unit 524. Implementation of the specifics of modular wiring replacement system 500 will be known and understood by artisans without undue experimentation.

FIG. 7 exemplifies an embodiment of replaced wire 502 with universal replaced wire end unit 504. According to embodiments, replaced wire 502 is a set of three subwires 506A, 506B, 506C. According to embodiments, any reasonable number of wires may be installed in a single embodiment of replaced wire 502. Artisans will appreciate the considerations of weight, flexibility, and diameter when choosing appropriate wires. The present disclosure intends that replaced wire end unit 504 may be adapted for use in nearly any wire. According to the exemplary embodiment shown in FIG. 7, subwires 506A, 506B, 506C of replaced wire 502 may be correspond to the three wires of a typical grounded electrical socket or may correspond to the three channels in a component video cable. A person of ordinary skill in the art will appreciate the variations on this theme.

These principles apply to both replaced wire 502 and replacement wire 522 without limitation. The above discussion referring to replaced wire 502 is merely to exemplify the principle at play. Artisans will recognize the necessity that the same principles apply equally to replacement wire 522.

When replaced wires 502 are installed, each may be labeled with a label identifying each individual wire. The labeling system may include a designation for the type of wire, as well as a random designator to allow for accurate identification of the ends of each individual wire. According to similar embodiments, tags may be provided and affixed to end units 504 of replaced wire 502. Tags may be coded by color, alphanumeric symbols, or other equivalent ways of uniquely identify two ends of replaced wire 502. According to embodiments, the length of each wire will be indicated, in addition to identification information to ensure replacement wire 522 of suitable length is obtained prior to replacing replaced wire 502.

Modular wiring replacement unit 500 is operated by locating the end of replaced wire 502. Replacement wire 522 is affixed to coupler 510. The unaffixed end of coupler 510 is affixed to an end of replaced wire 502. The other end of replaced wire 502 is pulled. As replaced wire 502 is removed, replacement wire 522 takes its place. When the end of replaced wire 502, coupler 510, and the end of replacement wire 522 emerges from pulling site, pulling is complete and the system may be dissembled. Replacement wire 524 may then be used and becomes replaced wire 502 for future iterations.

Installation of this system generally allows builders to create a system of modular wiring ports throughout a building. Various types of wires, such a electricity, ethernet, telephone, etc. may be routed to all or a large majority of wiring port housing 200 and connected to each wire port housing 200 as a default configuration. Users may then install removable wiring ports 100 without regard to the type of connection desired.

According to similar embodiments, wires may be installed as described above, except dummy wires with no function except to be replaced by replacement wire 522 may be included for replacement and routing of specialized wires throughout a building. For example, coaxial cable will experience signal degradation as the wire is “split.” Consequently, for wires such as coaxial cable, it will be desirable to route the coaxial cable to one or a small number of locations to reduce unnecessary signal degradation. According to embodiments, coaxial cable may be installed at all wiring port housings 200 in a living room, to allow maximum flexibility in locating a television, but omitted altogether in bathrooms, and in reduced numbers in bedrooms. According to an embodiment, coaxial cable may be routed to as many port housings 200 as desired. According to this embodiment, the coaxial cable signal may need to be boosted to prevent unacceptable levels of degradation. Artisans will know how to address these considerations without undue experimentation.

Additionally, generic, multifunction wires may be in stalled and used for a variety of purposes, where necessary. Moreover, according to embodiments, buildings may have wire conduits installed to connect general wiring conduits in the floor or ceiling to each wiring port housing 200 location. Building-wide wires may then be routed through the general wiring conduits in the ceiling or floors, and be reasonably accessible. These wires may then be easily connected to each wiring port housing 200, as described herein, by providing a plurality of general purpose wiring that may be connected at predetermined connection junctions as necessary to the wiring system contained in general wiring conduits, or pulled and replaced according to need. User need simply locate the general wiring conduits and the wire conduit associated with a given wiring port housing 200.

The average user will never be exposed to live wires, even user pulling and replacing wires. Thus, the present provides a novel system to address wiring issues within walls without the risk of electrocution or damage to connected components by static electricity.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A device comprising:
a removable wiring port having at least one internal wiring connector; and
a wiring port housing having at least one internal receptacle connected to the wiring of a building.

2. The device of claim 1, wherein the removable wiring port further comprises at least an external wiring connector connected to at least one internal wiring connector.

3. The device of claim 2, wherein the external wiring connector comprises at least one of electricity outlets, telephone ports, ethernet ports, coaxial cable ports.

4. The device of claim 2, wherein the at least one external wiring connector comprises at least connectors for audio systems or video systems.

5. The device of claim 2, wherein the at least one external wiring connector comprises an apparatus for the recharging of consumer electronic devices.

6. The device of claim 1, wherein the removable wiring port is integrated into a second device; and
wherein the internal wiring connector connects directly to the second device.

7. The device of claim 6, wherein the, second device comprises a ceiling fan or ceiling lighting fixture, and wherein the external wiring connector comprises wires connected directly to the apparatus of the second device requiring electricity.

8. The device of claim 7, further comprising a strain bar that releasable articulates with a mounting bracket to carry the weight of the second device.

9. The device of claim 2, wherein the removable wiring port

10. The device of claim 1, wherein the removable wiring port comprises a safety port that is disconnected from the at least one internal wiring connector.

11. The device of claim 1, wherein the removable wiring port further comprises an alignment guide and the wiring port house comprises a corresponding alignment guide to ensure the removable wiring port is position to correct interconnect with the internal wiring receptacles.

12. The device of claim 1, further comprising an engagement member for engaging internal wiring connectors from a retracted position into an interconnected position with the at least one internal wiring receptacle.

13. The device of claim 12, wherein the ports are not active until the engagement member is in the interconnected position.

14. A method comprising:
providing a removable wiring port to be installed into a housing for the removable wiring port with connectors for engaging the removable wiring port to live wiring, the removable wiring port having an engagement member to releasably engage the removable wiring port with live wiring.

15. The method of claim 14, further comprising providing a housing for the removable wiring port.

16. The method of claim 14, wherein the removable wiring port may be used to provide connection ports to live wires of electrical, telephone, computer networking, video cable, audio cable, and combinations thereof.

17. A method using a removable wiring port comprising:
inserting a removable wiring port into a wiring port housing, wherein the removable wiring port comprises at least an external wiring connector and an internal wiring connector connected to each external wiring connector and the removable port housing comprises at least one internal receptacle connected to the wiring of a building.

18. The method of claim 17, further comprising actuating an engagement member,
wherein actuation of an engagement member causes the interconnection of a wiring system in a building and at least one wire in the removable wiring port.

19. The method of claim 18, wherein the at least one external wiring connector is used to provide connection port to live electrical, telephone, computer networking, video cable, audio cable, and combinations thereof.
